(19) United States
(12) Patent Application Publication
(10) Pub. No.: US 2005/0108878 A1
(43) Pub. Date: May 26, 2005

(54) METHOD OF MANUFACTURING BEARING DEVICE, BEARING DEVICE, MOTOR AND RECORDING DISK DRIVING APPARATUS

(75) Inventors: Hideki Nishimura, Kyoto (JP); Yoshito Oku, Kyoto (JP); Junichi Takatera, Kyoto (JP); Chikara Sagae, Kyoto (JP); Kenichi Yamazaki, Kyoto (JP)

Correspondence Address: SHINJYU GLOBAL IP COUNSELORS, LLP, 1233 20TH STREET, NW, SUITE 700, WASHINGTON, DC, 20036-2680, US

(73) Assignee: NIDEC CORPORATION, Kyoto (JP)

(21) Appl. No.: 10/904,624

(22) Filed: Nov. 19, 2004

(30) Foreign Application Priority Data
Nov. 20, 2003 (JP) 2003-391045

(51) Int. Cl. B25G 3/02; B23B 5/22

(52) U.S. Cl. 29/898.07; 29/898.12

(57) ABSTRACT

The present invention has its main object in providing a bearing device of a motor superior in its resistance to impact and sliding performance. Therefore, according to the present invention, a shaft and a sleeve into which the shaft is inserted are formed from stainless steel, and a plating layer formed by means of an electroless nickel plating so as to have a phosphorous concentration of at least 6% and at most 12% and subjected to a precipitation hardening treatment in an atmosphere of at least 500° C. and at most 700° C. is provided on a surface of the shaft. Thereby, the sliding performance of the bearing device having a superior resistance to impact can be improved.

### BACKGROUND OF THE INVENTION

1. Field of the Invention

The present invention relates to a bearing device comprising a shaft and a sleeve, an electrically-driven motor and a disk driving apparatus.

2. Background Information

Conventionally, a motor comprising a bearing device in which a shaft is inserted into a sleeve having a cylindrical shape and the shaft is rotatably supported via lubricant oil is used for different types of electric apparatuses. For example, in a hard disk driving apparatus for memorizing various information, a recoding medium having a disk shape (that is hard disk), on which the information is magnetically recorded, is rotated by a motor and the information is thereby written and read by means of a head.

In such a motor, the shaft and the sleeve are directly brought into a sliding contact with each other (via very little lubricant oil therebetween) when the motor is activated and halted or undergoes a large external impact. When the contact occurs, if surfaces of the shaft and the sleeve are made of an identical material, the two components are likely to adhere to each other due to a frictional heat caused by their sliding contact. Therefore, the shaft and the sleeve are generally formed from different constituent materials (so-called material system). For example, one of the shaft and the sleeve is formed from stainless steel and thereafter subjected to a nitriding treatment, while the other is formed from stainless steel and directly used. A bearing device capable of maintaining a high abrasion-resistant property and controlling the generation of the adhesion can be thus constituted.

No. 11-223213 of the Publication of the Unexamined Japanese Patent Applications discloses a method wherein a nickel phosphorous-based electroless plating including phosphorous by 1 to 5% is performed to a sleeve to thereby form a sleeve having a high surface hardness and a high shape precision, and an electroless plating including fluorine resin powder by 3 to 20% and phosphorous by 7 to 15% is performed to a shaft so that the shaft and the sleeve can be prevented from adhering to each other.

In recent years, a hard disk driving apparatus is being utilized as a memory device for portable various electric apparatuses, which increasingly demands a reduction in size as well as a resistance to impact and a higher reliability. However, it is difficult to further improve a sliding performance relating to the resistance to impact and the reliability in the bearing device of the motor according to a conventional material system. In the method recited in No. 11-223213 mentioned earlier, the surface hardness of the sleeve can be increased, though the improvement of the resistance to impact is not necessarily guaranteed by the increase of the hardness.

### SUMMARY OF THE INVENTION

Therefore, the present invention has been achieved in order to solve the foregoing issues and a main object thereof is to provide a bearing device superior in its resistance to impact and sliding performance.

Another main object of the present invention is to provide a method of manufacturing the bearing device superior in its resistance to impact and sliding performance.

Still another main object of the present invention is to obtain a motor comprising the bearing device superior in its resistance to impact and sliding performance. Still another main object of the present invention is to provide a disk driving apparatus comprising the motor.

A method of manufacturing the bearing device according to the present invention comprises a step wherein a shaft member and a sleeve member are formed, a step wherein an electroless nickel plating is performed to one of the shaft member and the sleeve member to thereby form a plating layer having a phosphorous concentration of at least 6% and at most 12%, and a step wherein a precipitation hardening treatment is performed to the one of the members in an atmosphere of at least 500° C. and at most 700° C.

According to the present invention, the sliding performance in the bearing device comprising a superior resistance to impact can be improved, and the reliabilities of the motor having a high resistance to impact and the disk driving mechanism can be also improved.

The bearing device according to the present invention comprises a shaft and a sleeve into which the shaft is inserted, wherein one of the shaft and the sleeve comprises a plating layer formed by means of the electroless nickel plating so as to have a phosphorous concentration of at least 6% and at most 12% and subjected to the precipitation hardening treatment in an atmosphere of at least 500° C. and at most 700° C.

The electrically-driven motor according to the present invention comprises the bearing device described above and a driving mechanism for rotating the shaft relative to the sleeve.

The disk driving apparatus according to the present invention comprises a cabinet for housing a recording medium having a disk shape on which information is recorded, the motor fixed inside of the cabinet and serving to rotate the recording medium, and an access means for writing and reading the information with respect to the recording medium.

### BRIEF DESCRIPTION OF THE DRAWINGS

Referring now to the attached drawings, which form a part of this original disclosure.

FIG. 1 illustrates a structure of a hard disk driving apparatus.

FIG. 2 is a longitudinal sectional view illustrating a structure of a motor.

FIG. 3 is an enlarged view of a bearing device.

FIG. 4 is a flow chart of steps of manufacturing the bearing device.

FIG. 5 is an explanatory view of a tilt drop test.

FIGS. 6(a) through (i) each illustrates a result of an X-ray analysis of a plating layer with respect to a combination of a phosphorous concentration of the plating layer in a shaft and a treatment temperature in a precipitation hardening.

FIG. 7 illustrates a relationship between the treatment temperature in the precipitation hardening and the Vickers hardness when the phosphorous concentration of the plating layer is changed.

FIG. 8 is an explanatory view of the Falex test.

FIG. 9 illustrates a relationship between the treatment temperature in the precipitation hardening and an abrasion amount rate in the shaft when the phosphorous concentration of the plating layer is changed.

FIG. 10 illustrates a relationship between the treatment temperature in the precipitation hardening and an abrasion amount rate in V blocks when the phosphorous concentration of the plating layer is changed.

FIG. 11 illustrates a relationship between the treatment temperature in the precipitation hardening and a load at which seizure is generated when the phosphorous concentration of the plating layer is changed.

FIG. 12 illustrates a relationship between the treatment temperature in the precipitation hardening and a length of time until the seizure is generated when the phosphorous concentration of the plating layer is changed.

FIG. 13 illustrates a relationship between the treatment temperature in the precipitation hardening and an abrasion coefficient when the phosphorous concentration of the plating layer is changed.

### DETAILED DESCRIPTION OF THE PREFERRED EMBODIMENT

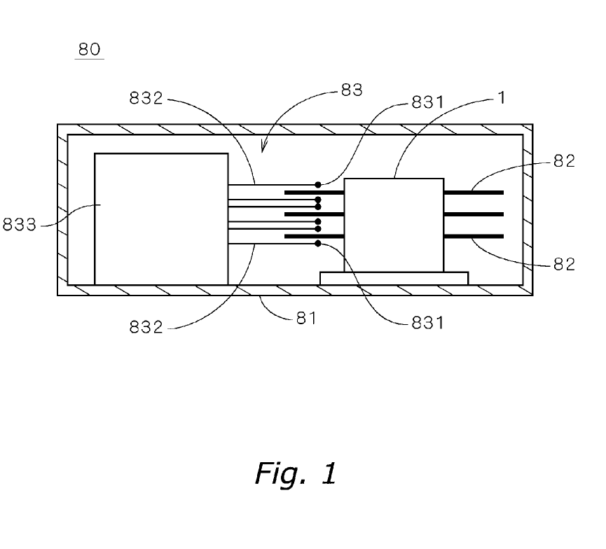

FIG. 1 illustrates an internal structure of a general hard disk driving apparatus 80 in which an electrically-driven motor 1 is installed according to an embodiment of the present invention. The inside of the hard disk driving apparatus 80 is a clean space where dust and dirt included therein are extremely rare because of a housing 81. The housing 81 houses therein recording disks 82 as recording media having a circular shape, an access unit 83 for writing and (or) reading information with respect to the recording disks 82 and a motor 1 for rotating the recording disks 82.

The access unit 83 comprises heads 831 for approaching a vicinity of the recording disks 82 and magnetically writing and reading the information with respect to the recording disks 82, arms 832 for supporting the heads 831 and a head moving mechanism 833 for changing relative positions of the heads 831 and the recording disks 82 by moving the arms 832. According to the structure, the heads 831 access required positions of the recording disks 82 remaining in the vicinity of the rotated recording disks 82 to thereby write and read the information.

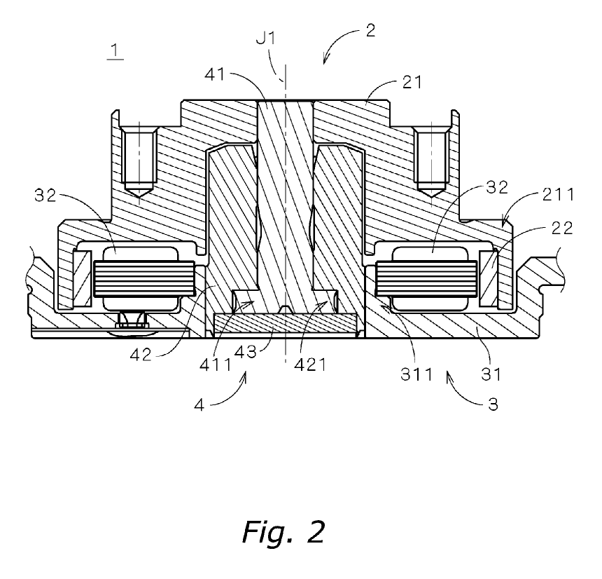

FIG. 2 is a longitudinal sectional view illustrating a structure of the motor 1 for driving the disks. The motor 1 comprises a rotor unit 2, which is a rotational body, and a stator unit 3, which is a fixed body. The rotor unit 2 is rotatably supported with respect to the stator unit 3 by means of a bearing device 4 including a shaft 41 and a sleeve 42.

The rotor unit 2 comprises a rotor main body 21 having a substantial cup shape and opening on the stator-unit-3 side (lower side in FIG. 2). The shaft 41 formed from stainless steel (for example, SUS303Cu) and having a plating layer on a surface thereof is fixed to the center of the rotor main body 21 in such manner as protruding on the opening side. On an outer peripheral surface of the rotor main body 21 is formed an annular protruding portion 211 extending outward and then bending downward on the stator-unit-3 side. A field magnet 22 magnetized in a multi-polar manner and having an annular shape is fixed to an inner peripheral surface of the annular protruding portion 211.

The stator unit 3 comprises a base plate 31 extending in a direction perpendicular to a central axis J1 of the shaft 41 and having a substantially circular shape, and a cylindrical portion 311 protruding upward is formed at the center of the base plate 31. The sleeve 42 made of stainless steel (for example, DHS-1) and having a substantially cylindrical shape, into which a free end side of the shaft 41 is inserted, is inserted into and fixed to the cylindrical portion 311. Further, in a periphery of the cylindrical portion 311 is provided an armature 32, in which windings are wound around a plurality of salient poles provided in an annular core, facing the central-axis-J1 side of the field magnet 22. The field magnet 22 and the armature 32 constitute a driving mechanism of the motor 1, wherein electric current supplied by a current supply circuit, which is not shown, connected to the armature 32 is controlled so as to generate a torque (rotational force) for rotating the rotor unit 2 around the shaft 41 serving as a rotational center with respect to the stator unit 3.

A thrust plate 411 having a circular shape and extending from the central axis J1 as a center of the extension is formed at an end portion on the free end side of the shaft 41. In an inner peripheral surface of the sleeve 42, an annular cutout portion 421 having an annular shape is formed on the free end side of the shaft 41. The thrust plate 411 is fitted into a circular space formed by the cutout portion 421. Further, a counter plate 43 for blocking a lower-side opening of the sleeve 42 is provided in an lower-side end portion of the sleeve 42. The counter plate 43 faces a lower surface of the thrust plate 411.

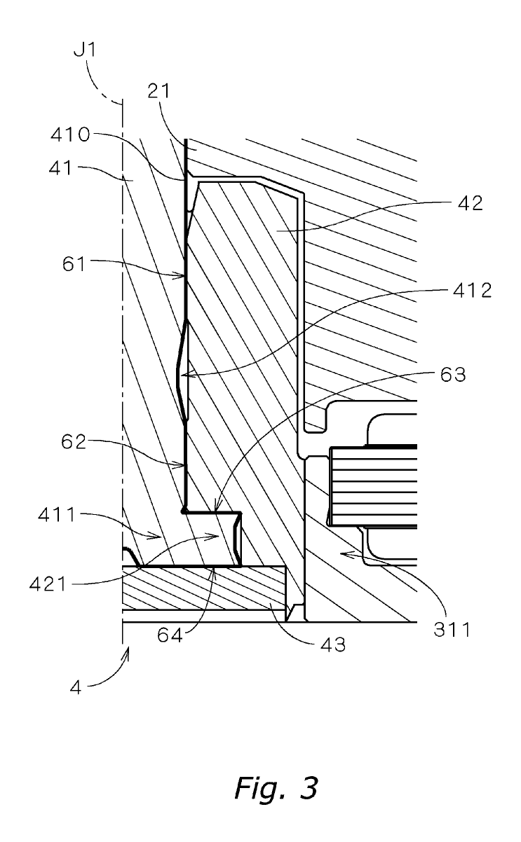

FIG. 3 is an enlarged view of the bearing device 4 of the motor 1, which shows only the right side of the structure from the central axis J1 shown in FIG. 2. As shown in FIG. 3, an annular groove 412 is formed on an outer peripheral surface of the shaft 41, and radial bearing portions 61 and 62 respectively filled with lubricant oil are formed on upper and lower sides relative to the annular groove 412 between the shaft 41 and the sleeve 42. In the radial bearing portions 61 and 62, a groove for generating fluid dynamic pressure (for example, herringbone groove) is formed on the inner peripheral surface of the sleeve 42, and the shaft 41 is thereby supported in a radial direction perpendicular to the central axis J1 when the motor 1 is rotated. In the radial bearing portions 61 and 62, a function thereof as radial bearing portions utilizing the fluid dynamic pressure can be exerted as a result of the formation of the groove for generating the fluid dynamic pressure on at least one of the outer peripheral surface of the shaft 41 and the inner peripheral surface of the sleeve 42.

Thrust bearing portions 63 and 64 filled with lubricant oil are respectively formed between an upper surface of the thrust plate 411 (annular surface) and a surface of the cutout portion 421 facing downward and between the lower surface of the thrust plate 411 and an upper surface of the counter plate 43. In the thrust bearing portions 63 and 64, a groove for generating the fluid dynamic pressure (for example, spiral groove of a pump-in type) is formed in the upper and lower surfaces of the thrust plate 411, and the shaft 41 is thereby supported in the central-axis-J1 direction (also called axial direction) when the motor 1 is rotated. In the thrust bearing portions 63 and 64, in the same manner as in the radial bearing portions 61 and 62, a function thereof as thrust bearing portions utilizing the fluid dynamic pressure can be exerted as a result of the formation of the groove for generating the fluid dynamic pressure in at least one of the opposing surfaces.

As described earlier, a plating layer 410 is formed on an entire surface of the shaft 41 in a manufacturing step described later under specific conditions.

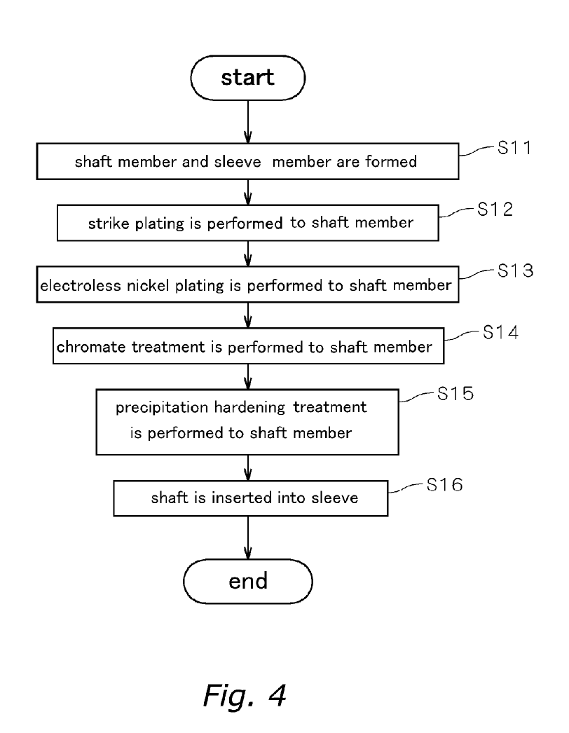

Next, a flow of steps of manufacturing the bearing device 4 of the motor 1 is described. FIG. 4 is a flow chart illustrating the steps of manufacturing the bearing device 4. In manufacturing the bearing device 4, a shaft member formed from stainless steel (that is a member constituting the shaft 41, on the surface of which the plating layer 410 is formed in a step described later) and a sleeve member (that is the sleeve 42) are manufactured by means of, for example, a cutting operation (Step S11). Then, such treatments as surface degreasing, removal of scales, surface activation, and the like, are performed when necessary. The shaft member is then subjected to a nickel strike plating, and a ground layer is formed (Step S12). When the strike plating is completed, the shaft member is subjected to an electroless nickel plating (that is a nickel phosphorous-based electroless plating), and the plating layer having a predetermined phosphorous concentration is formed on the ground layer of the shaft member (Step S13).

Thereafter, a chromate treatment is performed so as to form an anti-corrosive film (Step S14). Subsequent to a cleaning step, a precipitation hardening treatment is performed to the shaft member, and the amorphous plating layer is crystallized (Step S15). The precipitation hardening treatment is performed in the manner that an atmosphere in a furnace where the shaft member is disposed is heated to reach, for example, a predetermined temperature described later in 60 minutes, retained for approximately 60 minutes, and rapidly cooled down to 300° C. in 30 minutes. Then, the shaft 41, which is the shaft member on which the plating layer is formed, is inserted into the sleeve 42. Further, the counter plate 43 is mounted on another opening of the sleeve 42. The manufacturing of the bearing device 4 is thus completed (Step S16).

The strike plating in Step S12 and the chromate treatment in Step S14 are performed only when necessary in accordance with an adhesion property, anti-corrosion property and the like of the plating layer.

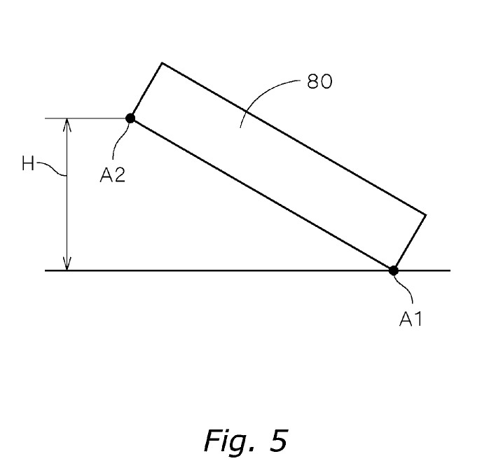

Next are described results obtained from tests for resistance to impact, which were implemented to the hard disk driving apparatus using the motor comprising the bearing device manufactured in the manufacturing steps illustrated in FIG. 4. Table 1 shows a result of a tilt drop test, which is an example of the impact tests. [″] in the Table 1 denotes inches. To describe the tilt drop test, as shown in FIG. 5, in the hard disk driving apparatus 80 comprising the motor driven at a rated rotation speed, a side where a side surface and a bottom surface of a rectangular housing intersect with each other is referred to as a support shaft A1, and a side A2 where a side surface on the opposite side of the side surface on the support-shaft-A1 side and the bottom surface intersect with each other is lifted to a predetermined height H and released so as to apply an impact to the hard disk driving apparatus 80. The resistance to impact is thereby evaluated based on whether or not the rotation of the motor is halted due to the applied impact. The test is known as an impact test added with a gyroscopic moment.

TABLE 1

| treatment | | | |
|---|---|---|---|
| temperature in | 6% | | |
| the precipitation | phosphorous | 7% phosphorous | 8% phosphorous |
| hardening | concentration | concentration | concentration |
| 350° C. | 2/2 | — | 2/2 |
| | 4″NG | | 5″NG |
| 500° C. | 2/2 | — | 2/2 |
| | 5″NG | | 6″NG |
| 600° C. | 2/2 | 1/1 | 2/2 |
| | OK for 7″ and | OK for 7″ and | OK for 7″ and |
| | upright position | upright position | upright position |
| 700° C. | 2/2 | — | 2/2 |
| | OK for 7″ and | | OK for 7″ and |
| | upright position | | upright position |

The Table 1 shows the result of the tilt drop test with respect to combinations of the phosphorous concentration of the plating layer in the shaft and the treatment temperature in the precipitation hardening when the bearing device is manufactured. Figures shown on upper right and left sides in columns corresponding to the combinations in the Table 1 respectively denote a quantity of tested samples and a quantity of samples from which results were obtained, while figures on the lower side denote the result of the test. In the test result, for example, [5″NG] denotes that the rotation of the motor halted when the impact was applied thereto at the height H of five inches (127 mm) (though the rotation of the motor did not halt when the height H was lower than five inches). [OK for 7″ and upright position] denotes that the rotation of the motor did not halt when the impact was applied thereto at the height H of seven inches (approximately 178 mm) and also that the rotation of the motor did not halt when the impact was applied thereto in the manner that the side A2 disposed directly above the support shaft A1 (state where the hard disk driving apparatus is disposed in the upright position with the height H being maximum) was dropped.

It is learnt from the Table 1 that a superior resistance to impact can be obtained when the phosphorous concentration is anything between 6% and 8% at the treatment temperatures of 600° C. and 700° C. in the precipitation hardening, which is supported by the result [OK for 7″ and upright position]. Further, when the treatment temperature in the precipitation hardening is 500° C., the respective results, [5″NG] and [6″NG], are obtained when the phosphorous concentration is 6% and 8%, which provides a favorable resistance to impact compared to the temperature of 350° C. For reference, it is generally known that too a high treatment temperature in the precipitation hardening serves to advance sensitization in the plating layer, which leads to the generations of carbon (C) among crystals and resultant intergranular corrosion. However, it has been confirmed that such a problem does not occur at any temperature below 700° C.

Focusing on the phosphorous concentration, the phosphorous concentration of 8% shows a better outcome than that of 6% when the treatment temperature is 350° C. and 500° C. in the precipitation hardening. It is learnt from the outcome that the resistance to impact improves as the phosphorous concentration increases. Therefore, in view of an empirical range of the phosphorous concentration by which the electroless nickel plating can be stably performed, a superior resistance to impact can be achieved when the phosphorous concentration is in the range of at least 6% and at most 12%.

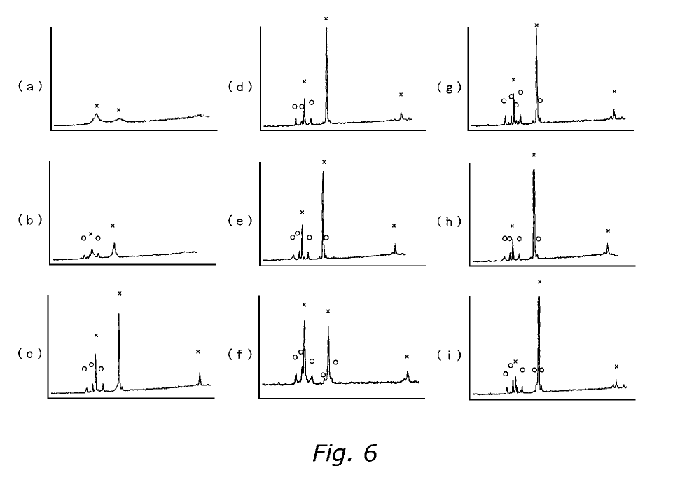

FIGS. 6(a) through (i) each illustrates a result of an X-ray analysis of the plating layer with respect to the combinations of the phosphorous concentration of the plating layer in the shaft and the treatment temperature in the precipitation hardening. Referring to peaks of spectrums shown in FIGS. 6(a) through (i), the peaks with O thereabove denote crystals of Ni3P, while the peaks with X thereabove denote crystals of Ni element.

FIGS. 6(a) and (b) show the results of X-ray analysis of the plating layer when the treatment temperature in the precipitation hardening is 350° C. and the phosphorous concentration is respectively 6% and 8%, wherein the peaks denoting the crystals of Nᵢ₃P are respectively zero and two showing that the crystallization of Nᵢ₃P is not quite advanced.

FIGS. 6(c) and (d) show the results of X-ray analysis of the plating layer when the treatment temperature in the precipitation hardening is 500° C. and the phosphorous concentration is respectively 6% and 8%, wherein the peaks denoting the crystals of Nᵢ₃P are respectively three showing that the crystallization of Nᵢ₃P is relatively advanced.

FIGS. 6(e) through (g) show the results of X-ray analysis of the plating layer when the treatment temperature in the precipitation hardening is 600° C. and the phosphorous concentration is respectively 6%, 7% and 8%. FIGS. 6(h) and (i) show the results of X-ray analysis of the plating layer when the treatment temperature in the precipitation hardening is 700° C. and the phosphorous concentration is respectively 6% and 8%. In FIGS. 6(e) through (i), there are respectively at least four peaks denoting the crystals of Nᵢ₃P showing that the crystallization of Nᵢ₃P is further advanced. In the comparison based on the respective treatment temperatures in the precipitation hardening, the crystallization of Nᵢ₃P is accelerated as the phosphorous concentration is increased. These obtained results are in agreement with the result of the tilt drop test shown in the Table 1, teaching that the resistance to impact improves as the crystallization of Nᵢ₃P advances.

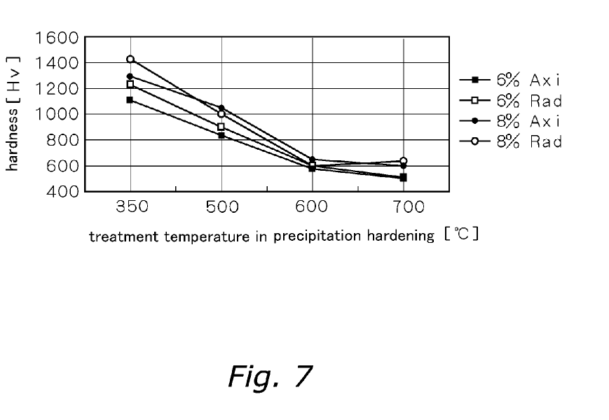

FIG. 7 illustrates a relationship between the treatment temperature in the precipitation hardening and the Vickers hardness (hereinafter, simply referred to as “hardness”) when the phosphorous concentration of the plating layer is changed. In FIG. 7, an average value of the hardness at positions on the outer peripheral surface of the shaft 41 respectively corresponding to the radial bearing portions 61 and 62 shown in FIG. 3 is represented by Rad, and an average value of the hardness at positions on the upper and lower surfaces of the thrust plate 411 respectively corresponding to the thrust bearing portions 63 and 64 is represented by Axi. Ratios shown prior to the Rad or the Axi are the respective phosphorous concentrations of the plating layer.

As shown in FIG. 7, the hardness decreases in a linear manner as the treatment temperature in the precipitation hardening increases in the range of 350° C.-600° C., while the hardness remains substantially constant at 600° C. and 700° C. From the above result and also taking the result of the tilt drop test shown in the Table 1 into consideration, when the treatment temperature in the precipitation hardening is low, the hardness increases while the resistance to impact decreases, and when the treatment temperature in the precipitation hardening is high, the hardness is lowered while the resistance to impact is improved. Therefore, it can be said that the resistance to impact achieved at the treatment temperature of 600° C. in the precipitation hardening is so exceptional that the rotation of the motor is not halted under the condition that the height H is maximum (upright position) in the tilt drop test and that sufficiently good resistance to impact can be obtained at the treatment temperature of approximately 550° C. in the precipitation hardening in view of the fact that the hardness decreases in the linear manner when the treatment temperature is 350° C.-600° C.

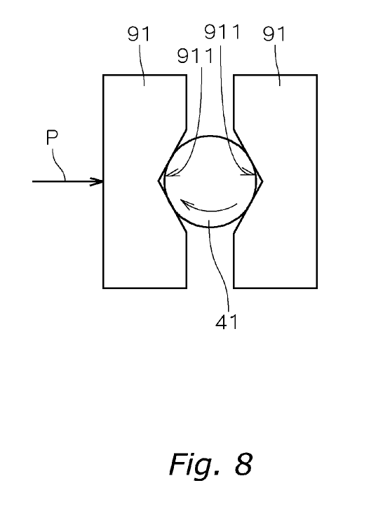

Next, the Falex test, which is another evaluation method for the bearing device 4, is described, as follows. As shown in FIG. 8, the shaft 41 is disposed between a pair of test pieces (hereinafter, referred to as “V blocks”) 91 made of stainless steel, which is the material used for the formation of the sleeve (to be accurate, a bar-shaped test piece made of stainless steel and having the plating layer as the material of the shaft 41 is sandwiched between cutouts 911 formed so as to face each other in the V blocks 91). One of the V blocks 91 is fixed and the other V blocks 91 is subjected to a load P while rotating the shaft 41 at a certain rotational speed (for example, 1200 rpm) constantly supplying the shaft 41 with lubricant oil. Then, a sliding performance, such as a length of time before the generation of seizure (or adhesion) starts and a magnitude of a load when the seizure is generated, is checked.

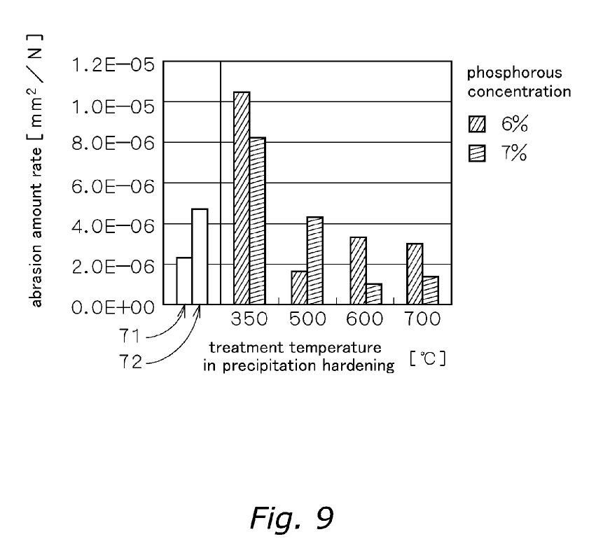

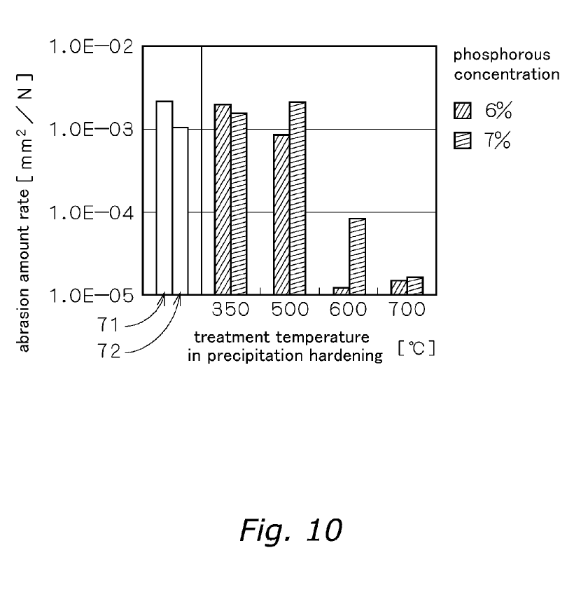

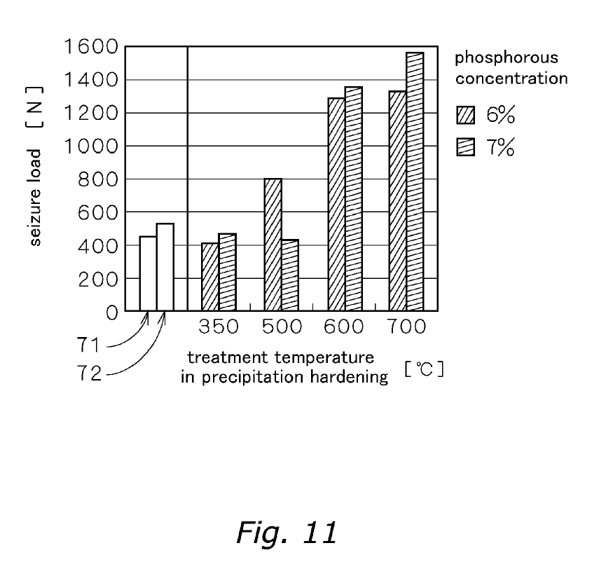

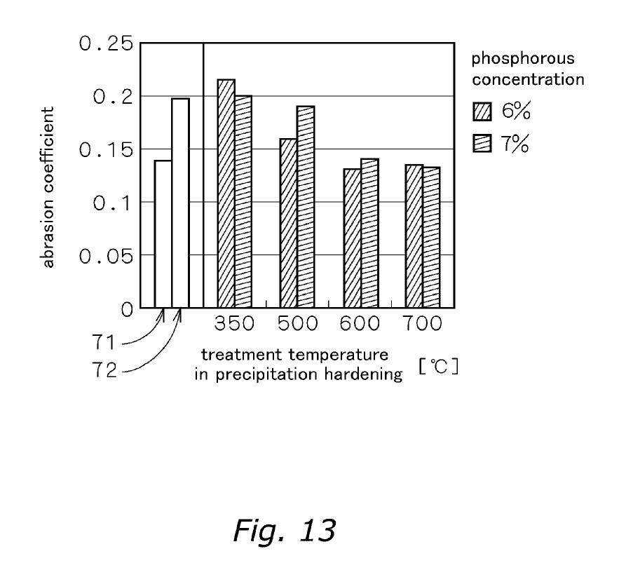

FIGS. 9 through 13 show different results obtained from the Falex test. FIGS. 9 and 10 illustrate a relationship between the treatment temperature in the precipitation hardening and an abrasion amount rate when the phosphorous concentration of the plating layer is changed, wherein the abrasion amount rate of the shaft 41 and the abrasion amount rate of the V blocks 91 are respectively shown. The abrasion amount rate denotes a value obtained by dividing an abrasion ratio (=(abrasion amount for volume)/(sliding distance)) by the load P. In FIGS. 9 and 10, as well as in FIGS. 11 and 13 described later, the shaft having the plating layer not subjected to the precipitation hardening treatment (hereinafter, non-treatment shaft) is shown with a reference symbol 71 appended thereto, and the shaft only subjected to a conventional nitriding treatment (hereinafter, referred to as nitriding-treatment shaft) is shown with a reference symbol 72 appended thereto.

As shown in FIG. 9, an anti-abrasion property in the shaft 41 is better when the treatment temperature in the precipitation hardening is 500° C.-700° C. and the phosphorous concentration is 6% and 7% than the effect obtained by the nitriding treatment. The abrasion amount rate in the V blocks 91 of FIG. 10 show a substantially same level as in the non-treatment shaft and the nitriding-treatment shaft when the treatment temperature in the precipitation hardening is 350° C. and 500° C., however is remarkably reduced when the temperature is 600° C. and 700° C.

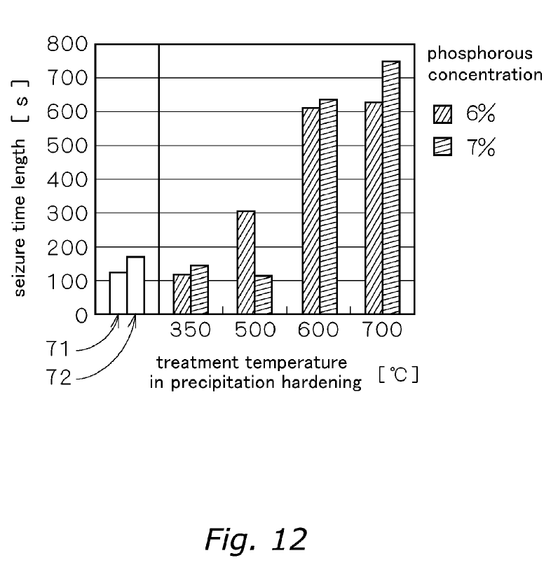

FIG. 11 illustrates a relationship between the treatment temperature in the precipitation hardening and the load by which the seizure is generated when the phosphorous concentration of the plating layer is changed. FIG. 12 illustrates a relationship between the treatment temperature in the precipitation hardening and the length of time before the generation of the seizure starts at a predetermined load. In FIGS. 11 and 12, the effect of the precipitation hardening treatment does not show any difference compared to the non-treatment shaft and the nitriding-treatment shaft in terms of the seizure load and the seizure time length of the shaft 41 when the treatment temperature in the precipitation hardening is 350° C. However, at 500° C.-700° C., the seizure load and the seizure time length both increase as the temperature increase, except when the phosphorous concentration is 7% at the temperature of 500° C. In particular, quite favorable results are obtained at the temperatures of 600° C. and 700° C.

Further, in FIGS. 11 and 12, the seizure load and the seizure time length significantly improves when the treatment temperature in the precipitation hardening is 500° C. to 600° C., from which it can be expected that a result more favorable than in the non-treatment shaft and the nitriding-treatment shaft can be obtained when the phosphorous concentration is 7% as long as the treatment temperature in the precipitation hardening is arranged to be 550° C.

FIG. 13 illustrates a relationship between the treatment temperature in the precipitation hardening and an abrasion coefficient when the phosphorous concentration of the plating layer is changed. In FIG. 13, the abrasion coefficient of the shaft 41 becomes smaller than that of the nitriding-treatment shaft when the treatment temperature in the precipitation hardening is 500° C.-700° C. Thus, the results obtained from the Falex test confirmed that a sliding performance exceeding that of the conventional nitriding-treatment shaft could be achieved when the treatment temperature in the precipitation hardening was arranged to be 500° C.-700° C.

As described, the motor 1 shown in FIG. 2 comprises the bearing device 4 including the shaft 41 and the sleeve 42, wherein the shaft 41 has the plating layer 410 on the surface thereof, and the plating layer 410 is formed with the phosphorous concentration of at least 6% and at most 12% by means of electroless nickel plating and subjected to the precipitation hardening treatment in the atmosphere of at least 500° C. and at most 700° C. The sleeve 42 is formed from a material different to that of the plating layer 410 in the shaft 41. Thus, the bearing device 4 comprising the shaft 41 and the sleeve 42 which are prevented from adhering to each other and having a superior resistance to impact can be realized. Thereby, the motor 1 can be prevented from any damage, which may be caused to its drive if a large impact is applied to the motor 1 rotated at a high speed. The sliding performance of the bearing device 4 can be improved, and the reliability of the motor 1 can be also improved. Further, when the motor 1 as described is used, the reliability of the hard disk driving apparatus 80 having a high resistance to impact can be improved.

As thus far described, the preferred embodiment of the present invention has been described, however the present invention is not limited thereto and can be variously modified.

The structure of the bearing device 4 according to the present embodiment is only an example of options and can be appropriately changed depending on a method of use.

In the bearing device 4, the plating layer formed by means of the electroless nickel plating and subjected to the precipitation hardening treatment may be formed on the sleeve 42. In order for the bearing device 4 to be easily manufactured, the plating layer is preferably formed on the shaft 41 having a simpler shape than the sleeve 42.

The shaft member or the sleeve member, on which the plating layer is formed, is not necessarily formed from stainless steel, and may be formed from other material in a feasible scope (for example, other metal materials such as phosphor bronze, iron or aluminum).

In the foregoing embodiment, the shaft 41 is fixed to the rotor unit 2 and rotated relative to the sleeve 42. As an alternative constitution, the sleeve 42 may be fixed to the rotor unit 2 (or integrally formed) and rotated relative to the shaft 41.

The motor 1 can be utilized for a device for driving, for example, an optical disk, a magneto-optical disk and a recording medium having a disk shape, other than the hard disk driving apparatus 80.

1. A method of manufacturing a bearing device characterized in comprising:
a step wherein a shaft member and a sleeve member are formed;
a step wherein an electroless nickel plating is performed to either the shaft member or the sleeve member; and
a step wherein a precipitation hardening treatment is performed to the one member.

2. A method of manufacturing a bearing device as claimed in claim 1, characterized in that
the precipitation hardening treatment is performed in an atmosphere of at least 500° C. and at most 700° C.

3. A method of manufacturing a bearing device as claimed in claim 1, characterized in that
a phosphorous concentration of the plating layer is at least 6% and at most 12% in the electroless nickel plating.

4. A method of manufacturing a bearing device as claimed in claim 1, characterized in that
the one member is formed from stainless steel.

5. A method of manufacturing a bearing device as claimed in claim 1, characterized in
the one of the members is the shaft member.

6. A method of manufacturing a bearing device characterized in comprising:
a step wherein a shaft member and a sleeve member are formed;
a step wherein an electroless nickel plating is performed to either of the shaft member or the sleeve member to thereby form a plating layer having a phosphorous concentration of at least 6% and at most 12%; and
a step wherein a precipitation hardening treatment is performed to the one member in an atmosphere of at least 500° C. and at most 700° C.

7. A method of manufacturing a bearing device as claimed in claim 6, characterized in further comprising:
a step wherein a groove for generating dynamic pressure is formed on either of an outer surface of the shaft or an inner surface of the sleeve.

8. A bearing device comprising a shaft and a sleeve into which the shaft is inserted, characterized in that
either of the shaft and the sleeve comprises a plating layer formed by means of an electroless nickel plating so as to have a phosphorous concentration of at least 6% and at most 12% and subjected to a precipitation hardening treatment in an atmosphere of at least 500° C. and at most 700° C.

9. A bearing device as claimed in claim 8, characterized in that
the either of the shaft or the sleeve is formed from stainless steel.

10. A bearing device as claimed in claim 8, characterized in that
the shaft comprises the plating layer.

11. A bearing device as claimed in claim 8, characterized in that
an outer surface of the shaft member faces an inner surface of the sleeve member via a fine interval therebetween, and
the plating layer is formed on either of the outer surface of the shaft member or the inner surface of the sleeve member.

12. A bearing device as claimed in claim 11, characterized in that a groove for generating dynamic pressure is formed on either of the outer surface of the shaft or the inner surface of the sleeve member facing each other, and
lubricant fluid is interpolated in the interval between the outer surface of the shaft and the inner surface of the sleeve member.

13. A bearing device as claimed in claim 12, characterized in that
the plating layer is formed on the outer surface of the shaft, and
the groove for generating dynamic pressure is formed on the inner surface of the sleeve member.

14. An electrically-driven motor characterized in comprising:
the bearing device recited in claim 8; and
a driving mechanism for rotating the shaft relative to the sleeve.

15. A disk driving apparatus characterized in comprising:
a cabinet for housing a recording medium having a disk shape on which information is recorded;
the motor recited in claim 14 fixed inside of the cabinet and serving to rotate the recording medium; and
an access means for writing and reading the information with respect to the recording medium.
